(19) United States
(12) Patent Application Publication
(10) Pub. No.: US 2006/0126621 A1
(43) Pub. Date: Jun. 15, 2006

(54) System, method and computer program for use in a publish/subscribe messaging system

(76) Inventors: Bharat V. Bedi, Southsea (GB); Martin J. Gale, Fair Oak (GB); Andrew J. Stanford-Clark, Chale (GB)

Correspondence Address: IBM CORPORATION;INTELLECTUAL PROPERTY LAW, 11400 BURNET ROAD, AUSTIN, TX, 78758, US

(21) Appl. No.: 11/257,450

(22) Filed: Oct. 24, 2005

(30) Foreign Application Priority Data
Dec. 14, 2004 (GB) 0427292.8

(51) Int. Cl. H04L 12/56

(52) U.S. Cl. 370/389

(57) ABSTRACT

A system for use in a publish/subscribe messaging system, the publish/subscribe messaging system having: a network, wherein the network has associated network data; and a broker having a matching engine for receiving at least one message from a publisher and for sending the at least one received message to a subscriber over the network. The at least one message has associated size metadata. The system comprises an intercept component for intercepting the at least one received message before sending by the matching engine and a receiving component for receiving the network data and the size metadata. A determining component, responsive to the receiving component, determines an instruction, which comprises a parameter associated with a time period over which the at least one received message is sent to the subscriber by the matching engine. The instruction is determined in accordance with the received network data and the size metadata.

### FIELD OF THE INVENTION

The present invention relates to a system, method and computer program for use in a publish/subscribe messaging system.

### BACKGROUND OF THE INVENTION

Publish and Subscribe (pub/sub) is an effective way of disseminating information to multiple users. Pub/Sub applications can help to enormously simplify the task of getting business messages and transactions to a wide, dynamic and potentially large audience in a timely manner.

Publishers are typically not concerned with where their messages are going, and subscribers are typically not interested in where the messages they receive have come from. Instead, a message broker typically assures the integrity of the message source and manages the distribution of the message according to the valid subscriptions registered in the broker.

Message topics typically provide the key to the delivery of messages between publishers and subscribers. The broker attempts to match a topic string on a published message with a list of clients who have subscribed to receive publications including that topic string.

In a unicast system, one copy of a message is sent by the broker to each subscriber that has registered an interest in the topic to which the message relates. In an example, if one hundred subscribers wish to receive information on the topic of sport, one hundred copies of each message relating to sport are sent out.

A problem with a unicast system is scalability. In a pub/sub system, a publisher of a message is decoupled from subscribers to that message, in that a publisher will not have information regarding the number of the subscribers, the network environment etc. Thus a publisher publishing a large volume of information can cause an impact on the network performance.

Thus, to lessen the impact on network performance, it is preferable to multicast messages which are to be sent to a number of subscribers. Unlike point-to-point TCP/IP socket-based pub/sub (where each subscriber listens on its own IP address for messages), subscribers in a multicast system listen on specific multicast addresses. Any number of subscribers may listen on the same multicast address. The broker performs the role of multicast transmitter and the subscribers each perform the role of multicast receiver. In a multicast system, using the example above, each message relating to sport is sent once to the multicast address and the one hundred subscribers receive the message by listening in on the multicast address.

Although multicasting messages partially solves the problem, there are some architectures that are incompatible with a multicast system. For example, multicasting is beneficial in architectures wherein many users receive the same message. However, in architectures such as those used to support the Internet, users can receive a message according to differing formats and thus unicasting a message is more appropriate, since with a unicast system, a copy of a message is sent to each subscriber.

Furthermore, in both multicast and unicast systems, the impact that sending a message will have on the network is not analysed.

Another solution is to send messages in batches. However, with this solution, the onus is on an administrator to construct batch sizes and to select an appropriate time for sending the batches, so as to minimize impact on the network.

Thus, there is a need for an improved system that maximises the efficiency of the network utilisation.

### DISCLSOURE OF THE INVENTION

According to a first aspect, there is provided a system for use in a publish/subscribe messaging system, the publish/subscribe messaging system having: a network, wherein the network has associated network data; and a broker having a matching engine for receiving at least one message from a publisher and for sending the at least one received message to a subscriber over the network, wherein the at least one message has associated size metadata; the system comprising: an intercept component for intercepting the at least one received message before sending by the matching engine; a receiving component for receiving the network data and the size metadata; and a determining component, responsive to the receiving component, for determining an instruction, in accordance with the network data and the size metadata, said instruction comprising a parameter associated with a time period over which the at least one received message is sent to the subscriber by the matching engine. Advantageously, the present invention allows an assessment of the impact of servicing one or more subscribers to be made in the broker.

Preferably, the system further comprises a parsing component for parsing the at least one received message in order to determine the size metadata. More preferably, the system further comprises a query component for querying a profile of network data in order to determine the relevant network data. Alternatively, the system further comprises a sampling component for sampling a network parameter in order to determine the network data.

Preferably, the subscriber has associated subscriber metadata and wherein the at least one received message is sent by unicast. More preferably, the size metadata is associated with a total size metadata that is determined in accordance with the size metadata and the subscriber metadata. This is because in a unicast system, each message is sent to each subscriber. Still more preferably, the instruction is determined in accordance with network data and the total size metadata. In one embodiment, the at least one received message is sent by multicast.

Preferably, wherein data of the at least one message is stored in a memory (e.g. a byte array). The system preferably comprises a control component for controlling the matching engine to send the at least one received message to the subscriber in accordance with the instruction. More preferably, the time period comprises one or more time portions. Still more preferably, the control component further comprises means for determining a size of a data portion of the data, in accordance with the network data and the one or more time portions.

Preferably, the control component further comprises means for reading the data portion from the memory and a first means for sending the data portion to the matching engine. In response to receiving the data portion, preferably, the matching engine comprises a second means for sending the data portion to the subscriber. Preferably, the system further comprises means for executing the reading means, first means for sending and second means for sending in accordance with the one or more time portions. More preferably, a factor is applied to a first value associated with the network data, such that in response to application of the factor, a second value associated with the network data is provided.

According to a second aspect, there is provided a method for use in a publish/subscribe messaging system, the publish/subscribe messaging system having: a network, wherein the network has associated network data; and a broker having a matching engine for receiving at least one message from a publisher and for sending the at least one received message to a subscriber over the network, wherein the at least one message has associated size metadata; the method comprising the steps of: intercepting the at least one received message before sending by the matching engine; receiving the network data and the size metadata; and in response to the receiving step, determining an instruction in accordance with the network data and the size metadata, said instruction comprising a parameter associated with a time period over which the at least one received message is sent to the subscriber by the matching engine.

According to a third aspect, there is provided a computer program comprising program code means adapted to perform all the steps of the method above, when said program is run on a computer.

### BRIEF DESCRIPTION OF THE DRAWINGS

The present invention will now be described, by way of example only, with reference to preferred embodiments thereof, as illustrated in the following drawings:

FIG. 1 is a schematic diagram of one data processing system in which the present invention may be implemented;

FIG. 2 is a schematic diagram of another data processing system in which the present invention may be implemented; and

FIG. 3 is a flow chart showing the operational steps involved in a process according to the present invention.

### DETAILED DESCRIPTION OF THE PREFERRED EMBODIMENTS

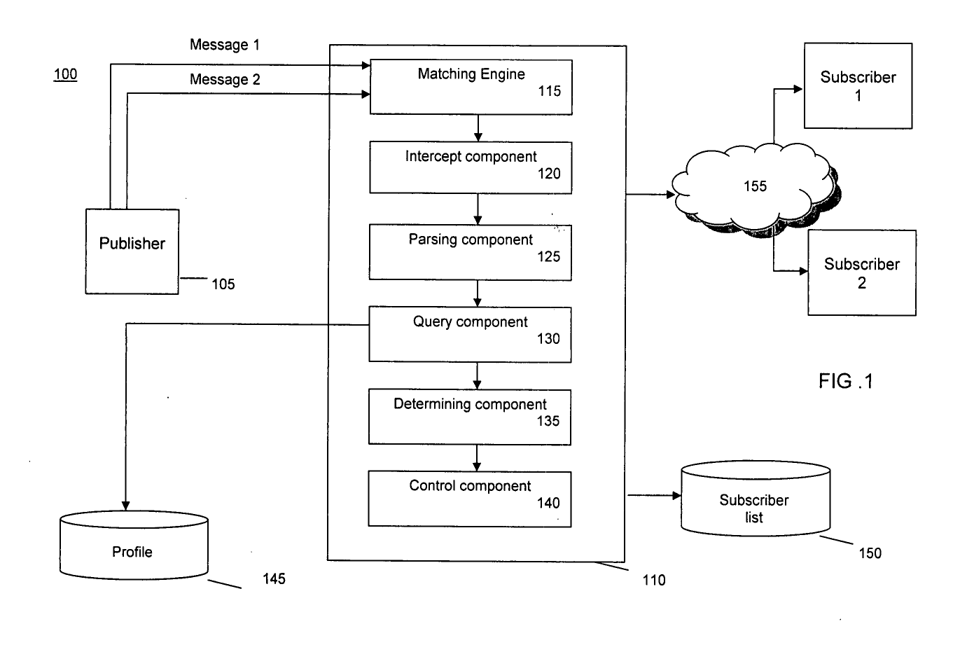

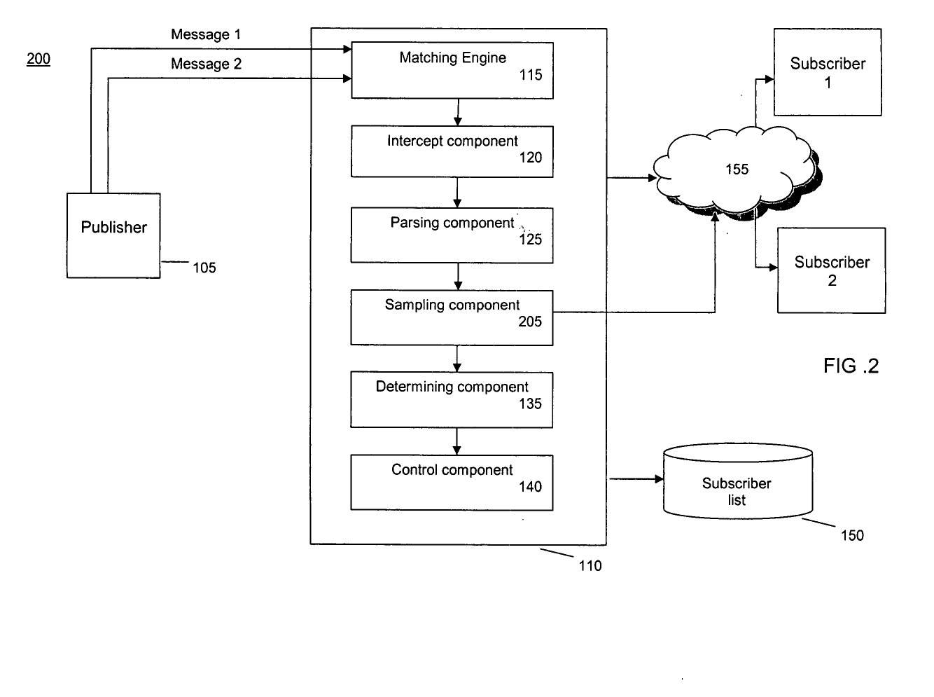

A system (100) according to a first embodiment is shown in FIG. 1 and a system (200) according to a second embodiment is shown in FIG. 2. With reference to the FIGS., a publisher (105) publishes at least one message to a broker (110), wherein the at least one message has associated data content, including a message header having metadata (termed herein “message metadata”) such as a topic string, message size etc. In this embodiment, the publisher (105) publishes two messages to the broker (110) (i.e. Message 1 and Message 2). A representation of message headers associated with the messages is shown below, each header comprising metadata associated with the topic string of the message, the size of the message (in this example, the size value comprises the size of the message data content as well as the size of the message header. However in another example, the size value comprises only the size of the message data content) and a timestamp indicating a time at which the message is received at the broker (110), wherein the format of the timestamp is time/day/month/year:

| Message 1 Header | |
|---|---|
| Topic String | Sport |
| Message Size | 4 MB |
| Timestamp | 19:01 27042004 |
| Message 2 Header | |
| Topic String | News |
| Message Size | 6 MB |
| Timestamp | 19:29 27042004 |

The broker (110) has access to a subscriber list (150), stored locally or remotely to the broker (110), comprising metadata (termed herein “subscriber metadata”) associated with clients who have subscribed to receive messages associated with one or more topic strings. In a unicast system, the list (150) also stores socket metadata (e.g. an address and a port number) that identifies a particular service (e.g. a subscriber's machine) on a particular node (e.g. an Internet node) on a network (e.g. the Internet). This is because, in a unicast system, a message is sent directly to each subscriber. In a multicast system, the list (150) also stores a multicast address, because in a multicast system, a message is sent once, to a multicast address. In this embodiment, Subscriber 1 and Subscriber 2 have subscribed with the broker (110). A representation of a unicast subscriber list and a multicast subscriber list is shown below. Preferably, the subscriber lists are held in one or more arrays.

Subscriber_array_unicast

| Subscriber: | Topic_strings: | Socket: |
|---|---|---|
| Subscriber 1 | Sport, News | 1.2.3.4; Port 12 |
| Subscriber 2 | Sport | 5.6.7.8; Port 13 |

Subscriber_array_multicast

| Subscriber: | Topic_strings: | Multicast_address: |
|---|---|---|
| Subscriber 1 | Sport, News | 10.11.12.13 |
| Subscriber 2 | Sport | |

The broker (110) comprises a known matching engine (115), which receives a message and matches a topic string of a received message with the topic strings in the subscriber list (150), so as to determine which subscribers to send the message to. If a subscriber is found, the message is sent over a network (155) (e.g. the Internet) to the subscribers for that message. In a first example, the message is sent by unicast and in a second example, the message is sent by multicast.

The network (155) has associated metadata (termed herein “network data”). In a first embodiment, the broker (110) receives the network data from a query component (130), which queries a profile (145). In a second embodiment, the broker (110) receives the network data from a sampling component (205) shown in FIG. 2.

The broker (110) also comprises an intercept component (120) for intercepting a message received by the matching engine (115). Preferably, the intercept component (120) stores data of the message in a memory. In the embodiments herein, the memory is a byte-organised memory, that is, a memory organised in bytes, such that each memory location is of one byte.

The broker (110) also comprises a parsing component (125) for parsing the intercepted message in order to determine the message metadata associated with the intercepted message. The broker (110) also comprises a determining component (135), which determines an instruction associated with sending a message. A control component (140), responsive to the determining component (135), controls the matching engine (115) to send a message in accordance with the instruction. It should be understood that components 120, 125, 130, 135, 140 and 205 can reside on a system separate to the broker (110).

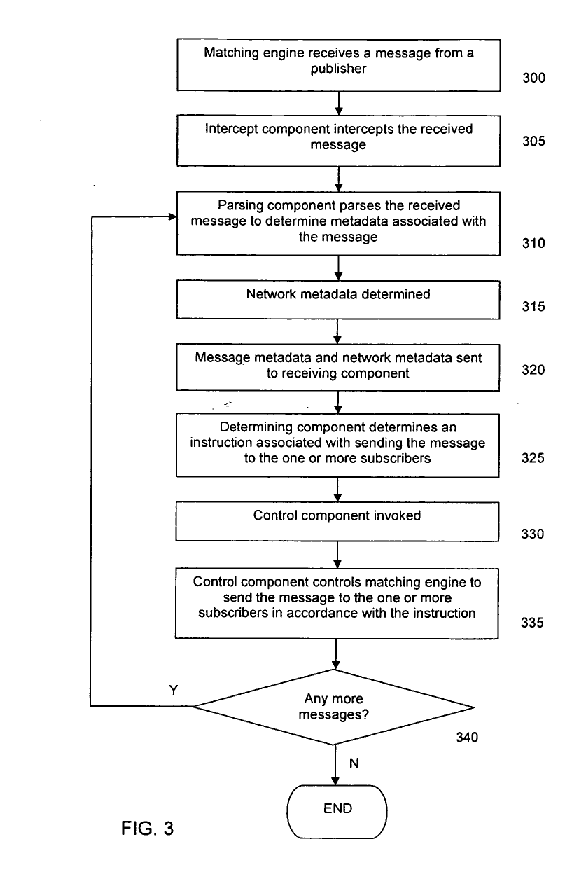

A process according to the first embodiment will now be described with reference to FIGS. 1 and 3. In step 300, Message 1 is received by the matching engine (115), from a publisher (105). It should be understood that in a prior art pub/sub system, Message 1 would be sent by the matching engine (115) as soon as it receives Message 1. However, according to the present invention, the intercept component (120) intercepts (step 305) Message 1 after it has been received by the matching engine (115) but before Message 1 is sent by the matching engine (115) to the subscriber(s) for Message 1. Message 1 is stored in a buffer in a byte-organised memory. In step 310, the parsing component (125) parses the intercepted Message 1 in order to determine the message metadata. Preferably, the parsing component (125) passes the message metadata to the determining component (135).

Next, in step 315, the network data is determined. With reference to FIG. 1, in the first embodiment, the query component (130) queries a profile (145) of historical statistics in order to determine network data. Preferably, in order to generate a profile (145), a profile generating component (not shown) monitors the pub/sub system for a given period of time, in order to collate averaged time-based historical statistics associated with the pub/sub system.

An example of a profile used with a unicast system is shown below, wherein each statistic has details associated with a time period, a size of message(s) that has been sent successfully over that time period and the number of subscribers for the messages (because in a unicast system, a copy of a message is sent to each subscriber):

Unicast Profile:

| Statistic | Time | Message size | Number of subscribers |
|---|---|---|---|
| Statistic 1 | 09:30-9:35 | 90 MB | 6 |
| Statistic 2 | 19:00-19:01 | 30 MB | 2 |

An example of a profile used with a multicast system is shown below wherein each statistic has details associated with a time period and a size of message(s) that has been sent successfully over that time period. The number of subscribers to a message is not needed, because in a multicast system a message is sent only once:

Multicast Profile

| Statistic | Time | Message size |
|---|---|---|
| Statistic 1′ | 09:30-9:35 | 90 MB |
| Statistic 2′ | 19:00-19:01 | 30 MB |

In the first example wherein a unicast system is used, preferably, the query component (130) uses the time-based historical statistics to determine network data.

Firstly, the query component (130) obtains the time value (i.e. 19:01) associated with Message 1, for example, from the parsing component (125). The query component (130) uses this time value to query the profile (145) for the most relevant statistic, for example, by searching the profile (145) until a statistic having a time period comprising the time value is found.

With reference to the unicast profile, the query component (130) uses the time value of Message 1 (i.e. 19:01) and finds a Statistic 2, having a time period of 19:00-19:01. Statistic 2 defines the message size as 30 MB and the number of subscribers as 2, for a time period of 19:00-19:01. Next, the query component (130) uses information in the statistic to determine network data according to logic set by a user, a computer system etc. In this example, the logic defines a message throughput, wherein “/” represents a divide function and “*” represents a multiply function:
Message throughput (MBps)=Size (MB)/time(s)*number of subscribers

Thus, if sent by unicast, a message throughput in MB per second is determined:
Message throughput=30/60×2=1 MB per second.

Thus, the message throughput represents the message throughput that can be handled by the network successfully and the message throughput represents the network data.

Next, the query component (130) sends (step 320) the network data to the determining component (135). As described above, the parsing component (125) sends (step 320) the message metadata to the determining component (135). The determining component (135) is associated with a receiving component that receives the network data and the message metadata, so that the determining component (135) can use the network data and the message metadata as described below.

The determining component (135) determines a total message size that is to be sent across the network (155) in accordance with logic set by a user, a computer system etc. The determining component (135) uses the message size in the message metadata for Message 1 and uses the subscriber metadata in subscriber_array_unicast in order to determine the number of subscribers for Message 1 (i.e. two). The logic is shown below:
Total message size (MB)=Message size*number of subscribers

In this example, the determined total message size is shown below:

$$Total message size = 4 * 2 = 8 MB$$

Next, the determining component (135) uses the values for total message size and the network data in order to determine a time period over which one or more messages are sent to one or more associated subscribers, in accordance with logic set by a user, a computer etc. The logic is shown below:
Time period=“total message size/network data”

In this example, the determined time period is shown below:

$$Time period = 8 MB / 1 MBps = 8 s$$

The determining component (135) now determines (step 325) an instruction, comprising variables, namely “subscriber_array_unicast”, “message”, “number_message” and “time_period”. The variable “subscriber_array_unicast” points to the array of subscribers used in a unicast system shown above, so that the subscribers (i.e. “<subscriber>”) associated with the message to be sent can be found and also the associated sockets (i.e. “<socket>”) can be found. The variable “message” points to the message that has been intercepted in the broker (110). The variable “number_message” represents the number of messages to be sent across the network (155). The variable “time_period” represents the time period over which the messages should be sent (i.e. the time period determined in accordance with the logic—described above):

Instruction(subscriber_array_unicast<subscriber><socket>; message; number_message; time_period)

An instruction comprising values for the variables is shown below and defines that two copies of Message 1 can be sent over the network (155) (i.e. one copy each to Subscriber 1 and Subscriber 2) over a time period of eight seconds:

Instruction(Subscriber 1, 1.2.3.4, port 12; Subscriber 2, 5.6.7.8, port 13; Message 1; 2; 8) In response to the instruction being created, the control component (140) is invoked (step 330) and controls (step 335) the matching engine (115) to send Message 1 in accordance with the instruction. Thus, a copy of Message 1 is sent to both Subscriber 1 and Subscriber 2 by the matching engine (115) over a time period of eight seconds.

A preferred embodiment of a control process used by the control component (140) will now be described. Preferably, the control component (140) is associated with a system clock. Preferably, the time period comprises one or more time portions, and firstly, the value of a time portion is input to the control component (140). In one example, the time period comprises one time portion of eight seconds. In this embodiment, the time period comprises eight time portions, wherein each time portion has a value of one second.

Next, the control component (140) determines a first size associated with Message 1, in accordance with the network data and the time portion, wherein the first size is less than or equal to a second size that can be transferred in a time portion. In this example, the first size is equal to a second size that can be transferred in a time portion. Thus, because the network data is 1 MBps, in a time portion of one second, 1 MB (i.e. a second size) of data can be transferred. Thus, the first size associated with Message 1 is also 1 MB.

The control component (140) then establishes a connection with a subscriber. In this example, the control component (140) opens sockets associated with Subscriber 1 (i.e. 1.2.3.4; port 12) and Subscriber 2 (i.e. 5.6.7.8, port 13), by using the socket metadata stored in the subscriber list (150).

Next, a system clock is started and the control component (140) reads from the byte-organised memory, a first data portion of the data of Message 1, wherein the size of the first data portion is equal to the first size (i.e. a 1 MB data portion). Specifically, the control component (140) reads data from the first 1024 locations of the byte-organised memory (that is, because each location is of a byte and 1024 bytes is 1 megabyte).

Next, the control component (140) sends the first data portion to the matching engine (115), which then sends the first data portion to a subscriber, in this example, Subscriber 1, over the opened socket connection. The control component (140) waits in accordance with the time portion (i.e. waits until one second has passed from the system clock being started, in accordance with signals sent by the system clock), before reading a second data portion from the next 1024 locations. It should be understood that the subscriber also comprises a buffer into which it receives the data portions.

The process of reading and sending by the control component and sending by the matching engine is repeated until all of the data has been sent to Subscriber 1 and all of the data has been sent to Subscriber 2. In this example, the process occurs eight times in total (because the time period has eight time portions).

Preferably, rather than sending data to each associated subscriber in the list according to a sequential order (i.e. first to Subscriber 1, then to Subscriber 2), data is sent to each associated subscriber in a random order, to ensure fairness of delivery.

In the second example wherein a multicast system is used, preferably, the query component (130) uses the time-based historical statistics to determine network data.

With reference to the multicast profile, for Message 1, the query component (130) executes a query as described above and finds a Statistic 2′, having a time period of 19:00-19:01. Statistic 2′ defines the message size as 30 MB, for a time period of 19:00-19:01. Next, the query component (130) uses information in the statistic to determine network data according to logic set by a user, a computer system etc. In this example, the logic defines a message throughput. Note that in this example, the logic does not comprise a number of subscribers parameter, because in a multicast system, each message is sent only once to a multicast address:
Message throughput (MBps)=Size (MB)/time(s)

Thus, if sent by multicast, a message throughput in MB per second is determined:
Message throughput=30/60=0.5 MB per second.

Thus, the message throughput represents the message throughput that can be handled by the network successfully and the message throughput represents the network data.

Next, the query component (130) sends (step 320) the network data to the determining component (135). As described above, the parsing component (125) sends (step 320) the message metadata to the determining component (135). The determining component (135) determines a total message size that is to be sent across the network (155) in accordance with logic set by a user, a computer system etc. The determining component (135) uses the message size in the message metadata for Message 1. Note that in this example, the logic does not comprise a number of subscribers parameter, because in a multicast system, each message is sent only once to a multicast address:
Total message size (MB)=Message size

In this example, the determined total message size is shown below:
Total message size=4 MB

Next, the determining component (135) uses the values for total message size and the network data in order to determine a time period over which one or more messages are sent to one or more associated subscribers in accordance with logic set by a user, a computer etc. The logic is shown below:

Time period=“total message size/network data”

In this example, the determined time period is shown below:

$$Time periods = 4 MB / 0.5 MBps = 8 s$$

The determining component (135) now determines (step 325) an instruction, comprising variables, namely “subscriber_array_multicast<subscriber><multicast_address>”, “message”, “number_message“ and “time_period”. The variable “subscriber_array_multicast” points to the array of subscribers so that the that the subscribers (i.e. “<subscriber>”) associated with the message to be sent can be found and the multicast address (i.e. “<multicast_address”>) associated with subscribers can be found. The variable “message” points to the message that has been intercepted in the broker (110). The variable “number_message” represents the number of messages to be sent across the network (155). The variable “time_period” represents the time period over which the messages should be sent (i.e. the time period determined in accordance with the logic—described above):

Instruction(subscriber_array_multicast<subscriber><multicast_adress>; message; number_message; time_period)

An instruction comprising values for the variables is shown below and defines that one copy of Message 1 can be sent over the network (155) (i.e. one copy to the multicast address) over a time period of eight seconds:

Instruction(Subscriber 1; Subscriber 2; 10.11.12.13; Message 1; 1; 8)

In response to the instruction being created, the control component (140) is invoked (step 330) and controls (step 335) the matching engine (115) to send Message 1 in accordance with the instruction. Thus, a copy of Message 1 is sent to the multicast address by the matching engine (115) over eight seconds. In this embodiment, the time period comprises sixteen time portions, wherein each time portion has a value of 0.5 second.

Next, the control component (140) determines a first size associated with Message 1, in accordance with the network data and the time portion, wherein the first size is less than or equal to a second size that can be transferred in a time portion. In this example, the first size is equal to a second size that can be transferred in a time portion. Thus, because the network data is 0.5 MBps, in a time portion of 0.5 s, 0.25 MB (i.e. a second size) of data can be transferred. Thus, the first size associated with Message 1 is also 0.25 MB.

The control component (140) then establishes a connection with a subscriber. In this example, the control component (140) establishes a connection to the multicast address, 10.11.12.13, by using the multicast address metadata stored in the subscriber list (150).

Next, a system clock is started and the control component (140) reads from the byte-organised memory, a first data portion of the data of Message 1, wherein the size of the first data portion is equal to the first size (i.e. a 0.25 MB data portion). Specifically, the control component (140) reads data from the first 256 locations of the byte-organised memory (that is, because each location is of a byte and 256 bytes is 0.25 megabyte).

Next, the control component (140) sends the first data portion to the matching engine (115), which then sends the first data portion to the multicast address. The control component (140) waits in accordance with the time portion (i.e. waits until 0.5 second has passed from the system clock being started, in accordance with signals sent by the system clock), before reading a second data portion from the next 256 locations.

The process of reading and sending by the control component and sending by the matching engine is repeated until all of the data has been sent once to the multicast address. In this example, the process occurs sixteen times in total (because the time period has sixteen time portions).

Next, the process passes to step 340, wherein a determination is made as to whether any further message(s) has been received into the buffer. If no further messages have been received, (negative result to step 340), the process ends. If a further message has been received, the process passes to step 305. In this embodiment, a further message, Message 2 has been received (positive result to step 340), and therefore the process passes to step 310.

In a second embodiment, the network data is determined by a sampling component (205), shown in FIG. 2, which samples a parameter associated with the network in order to determine network data. Thus, statistics of historical data as described with reference to FIG. 1, are not used.

In a preferred embodiment, a factor associated with the network data is set. The factor can be set by a user, a computer system etc. The setting of a factor allows for alteration of the value of the network data used in the present invention. Advantageously, this allows for performance to be optimised.

Using the first example described above, wherein the message throughput is the network data and the query component (130) determines the value of the message throughput to be 1MB per second, a factor of 125% is set (e.g. by a user, a computer system etc.). This factor is applied to the message throughput to determine an altered value for the message throughput (and therefore, the network data):

$$Altered message throughput ( MBps ) = 125 \% * 1 = 1.25 MBps$$

Now, the determining component (135) determines a total message size as described above, that is, 8 MB. Next, the determining component (135) uses the values for total message size and the altered network data in order to determine a time period over which one or more messages are sent to one or more associated subscribers, in accordance with logic set by a user, a computer etc. The logic is shown below:

Time period=“total message size/altered network data”

In this example, the determined time period is shown below:

$$Time period = 8 MB / 1.25 MBps = 6.4 s$$

The new value for time period is now used by the determining component (135) when determining (step 325) an instruction:

Instruction(subscriber_array_unicast<subscriber><socket>; message; number_message; time_period)

The resulting instruction is shown below:

Instruction(Subscriber 1, 1.2.3.4, port 12; Subscriber 2, 5.6.7.8, port 13; Message 1; 2; 6.4)

In this example, a factor that results in an altered network data value that is more than the original network data value has been set. The result is that a message is sent to subscribers over a shorter period of time (as described above, the time period of the first example was eight seconds). Advantageously, a factor that results in an altered network data value that is more than the original network data value can be used in an environment wherein network utilisation can be maximised (e.g. in an environment wherein no other applications apart from the broker (110) are using the network).

Using the second example described above, wherein the message throughput is the network data and the query component (130) determines the value of the message throughput to be 0.5MB per second, a factor of 50% is set (e.g. by a user, a computer system etc.). This factor is applied to the message throughput to determine an altered value for the message throughput (and therefore, the network data):

$$Altered message throughput ( MBps ) = 50 \% * 0.5 = 0.25 MBps$$

Now, the determining component (135) determines a total message size as described above, that is, 4MB. Next, the determining component (135) uses the values for total message size and the altered network data in order to determine a time period over which one or more messages are sent to one or more associated subscribers, in accordance with logic set by a user, a computer etc. The logic is shown below:

Time period =“total message size/altered network data”

In this example, the determined time period is shown below:

$$Time periods = 4 MB / 0.25 MBps = 16 s$$

The new value for time period is now used by the determining component (135) when determining (step 325) an instruction:

Instruction(subscriber_array_multicast<subscriber><multicast_address>; message; number_message; time_period)

The resulting instruction is shown below:

Instruction(Subscriber 1, Subscriber 2, 10.11.12.13; Message 1; 1; 16)

In this example, a factor that results in an altered network data value that is less than the original network data value has been set. The result is that a message is sent to subscribers over a longer period of time (as described above, the time period of the second example was eight seconds).

Advantageously, a factor that results in an altered network data value that is less than the original network data value can be used in an environment wherein it is preferable that the impact on a network is minimised (e.g. in an environment wherein other applications as well as the broker (110) are using the network).

It should be understood that the present invention can be used with existing multicast systems, existing unicast systems and existing hybrid systems offering multicast and unicast messaging.

1. A system for use in a publish/subscribe messaging system, the publish/subscribe messaging system having: a network, wherein the network has associated network data; and a broker having a matching engine for receiving at least one message from a publisher and for sending the at least one received message to a subscriber over the network, wherein the at least one message has associated size metadata; the system comprising:
an intercept component for intercepting at least one received message before sending by the matching engine;
a receiving component for receiving network data and size metadata; and
a determining component, responsive to the receiving component, for determining an instruction, in accordance with the network data and the size metadata, said instruction comprising a parameter associated with a time period over which the at least one received message is sent to the subscriber by the matching engine.

2. A system as claimed in claim 1, further comprising a parsing component for parsing the at least one received message in order to determine the size metadata.

3. A system as claimed in claim 1, further comprising a query component for querying a profile of network data in order to determine the relevant network data.

4. A system as claimed in claim 1, further comprising a sampling component for sampling a network parameter in order to determine the network data.

5. A system as claimed in claim 1, wherein the subscriber has associated subscriber metadata and wherein the at least one received message is sent by unicast.

6. A system as claimed in claim 5, wherein the size metadata is associated with a total size metadata that is determined in accordance with the size metadata and the subscriber metadata.

7. A system as claimed in claim 6, wherein the instruction is determined in accordance with network data and the total size metadata.

8. (canceled)

9. (canceled)

10. A system as claimed in claim 1, further comprising:
a control component for controlling the matching engine to send the at least one received message to the subscriber in accordance with the instruction, wherein the time period comprises one or more time portions, and wherein the control component further comprises:
means for determining a size of a data portion of the data, in accordance with the network data and the one or more time portions; and
means for reading the data portion from memory.

11. (canceled)

12. (canceled)

13. (canceled)

14. A system as claimed in claim 10, wherein the control component comprises a first means for sending the data portion to the matching engine, and wherein the matching engine comprises a second means for sending the data Portion to the subscriber.

15. (canceled)

16. (canceled)

17. (canceled)

18. A method for use in a publish/subscribe messaging system, the publish/subscribe messaging system having: a network, wherein the network has associated network data; and a broker having a matching engine for receiving at least one message from a publisher and for sending the at least one received message to a subscriber over the network, wherein the at least one message has associated size metadata, the method comprising the steps of:
intercepting at least one received message before sending by the matching engine;
receiving network data and size metadata; and
in response to the receiving step, determining an instruction in accordance with the network data and the size metadata, said instruction comprising a parameter associated with a time period over which the at least one received message is sent to the subscriber by the matching engine.

19. A method as claimed in claim 18, further comprising the step of: parsing the at least one received message in order to determine the size metadata.

20. A method as claimed in claim 18, further comprising the step of: querying a profile of network data in order to determine the relevant network data.

21. A method as claimed in claim 18, further comprising the step of: sampling a network parameter in order to determine the network data.

22. A method as claimed in claim 19, wherein the subscriber has associated subscriber metadata and wherein the at least one received message is sent by unicast.

23. A method as claimed in claim 22, wherein the size metadata is associated with a total size metadata that is determined in accordance with the size metadata and the subscriber metadata.

24. A method as claimed in claim 23, wherein the instruction is determined in accordance with network data and the total size metadata.

25. (canceled)

26. (canceled)

27. A method as claimed in claim 18, further comprising:
controlling the matching engine to send the at least one received message to the subscriber in accordance with the instruction, wherein the time period comprises one or more time portions, and wherein the controlling further comprises:
determining a size of a data portion of the data, in accordance with the network data and the one or more time portions; and
reading the data portion from memory.

28. (canceled)

29. (canceled)

30. (canceled)

31. A method as claimed in claim 27, further comprising:
sending, by the control component, the data portion to the matching engine; and
sending, by the matching engine, the data portion to the subscriber.

32. (canceled)

33. (canceled)

34. A method as claimed in claim 18, further comprising the step of: applying a factor to a first value associated with the network data, such that in response to application of the factor, a second value associated with the network data is provided.

35. A computer program comprising program code means adapted to perform a method for use in a publish/subscribe messaging system, the publish/subscribe messaging system having: a network, wherein the network has associated network data; and a broker having a matching engine for receiving at least one message from a publisher and for sending the at least one received message to a subscriber over the network, wherein the at least one message has associated size metadata, when said program is run on a computer said computer program code means comprising:
computer program code means for intercepting at least one received message before sending by the matching engine;
computer program code means for receiving network data and size metadata; and
computer program code means responsive to the computer program code means for receiving, for determining an instruction, in accordance with the network data and the size metadata, said instruction comprising a parameter associated with a time period over which the at least one received message is sent to the subscriber by the matching engine.
